(19) United States
(12) Patent Application Publication
(10) Pub. No.: US 2009/0307922 A1
(43) Pub. Date: Dec. 17, 2009

(54) GAS HEATER AND DRYER THEREWITH

(75) Inventor: Chang Hoo Kim, Gyeyang-gu (KR)

Correspondence Address: OCCHIUTI ROHLICEK & TSAO, LLP, 10 FAWCETT STREET, CAMBRIDGE, MA, 02138, US

(73) Assignee: Daewoo Electronics Corporation, Seoul (KR)

(21) Appl. No.: 12/140,473

(22) Filed: Jun. 17, 2008

(51) Int. Cl. F26B 19/00; F28C 3/10; F23Q 1/00; F28C 3/00

(52) U.S. Cl. 34/86; 432/219; 432/222; 431/254

(57) ABSTRACT

A gas heater with improved combustion efficiency and a dryer comprising the same are disclosed herein. The gas heater includes a cabinet, a gas tube disposed inside the cabinet to supply a gas into the cabinet, a nozzle provided to the gas tube, a mixing tube disposed to face the nozzle such that air and the gas can be mixed in the mixing tube, and a mixing member provided to the mixing tube to generate a vortex of air flowing into the mixing tube.

### BACKGROUND OF THE INVENTION

1. Field of the Invention

The present invention relates to a dryer, and more particularly to a gas heater with improved combustion efficiency and a dryer comprising the same.

2. Description of the Related Art

FIG. 1 is a schematic sectional view showing a flow passage of a conventional dryer, and FIG. 2 is a partially cut-away perspective view of the conventional dryer.

Referring to FIGS. 1 and 2, the conventional dryer includes a case 2 constituting an outer appearance of the dryer and having a door mounted on the front side thereof to open or close an opening through which an item to be dried is placed into or removed from the dryer, a drum 12 rotatably disposed inside the case 2 to receive the item and opened to allow air to pass through the drum in a forward and rearward direction, a heater 18 disposed inside the case 2 to heat air being suctioned into the drum, an intake duct 20 guiding the air heated by the heater 18 to the rear of the drum 12, an exhaust means 22 for discharging air to the outside of the case 2 after drying the item, a ventilation fan (not shown) provided to the exhaust means 22, and a motor (not shown) and a fan belt 40 for driving the drum and 12 and the ventilation fan.

The drum 12 has lifters 11 disposed on an inner surface thereof to lift and drop the item to be dried during a drying operation.

The exhaust means 22 includes a lint duct 25 defining a passage of air discharged from the drum 12 and having a filter 24 for separating foreign matter from air flowing through the lint duct 25, a fan housing 26 communicating with the lint duct 25 and surrounding the ventilation fan (not shown), and an exhaust duct 27 having one end communicating with the ventilation fan and the other end disposed outside the case 2.

Operation of the conventional dryer will be described below.

First, when the dryer is operated with an item to be dried, for example, laundry, received in the drum 12, the motor is driven to rotate the drum 12 and the ventilation fan, and the heater 18 is operated.

While the drum 12 is rotated, the laundry received in the drum 12 is lifted by the lifters 11 and then falls down inside the drum 12. Further, while being suctioned into the drum through the heater 18 by a ventilation force caused by rotation of the ventilation fan, external air is changed into high-temperature, low-humidity air by the heater 18 and flows into the drum 12 through the intake duct 20.

Inside the drum 12, high-temperature, low-humidity air passed into the drum 12 directly contacts and dries the laundry being tumbled in the drum 12. Then, the air changes into low-temperature, high-humidity air while moving towards the front side of the drum 12, and is finally discharged to the outside of the dryer through the exhaust duct 27.

In the conventional dryer, however, since the heater is constituted by a coil that is disposed inside a tube communicating with the intake duct and is heated by electric power supplied from the outside, it takes a long time to permit the heater to regularly operate after the drying operation is started. Further, since the conventional dryer employs relatively expensive electric energy as a heat source, a user of the conventional dryer inevitably suffers from high operation costs.

### SUMMARY OF THE INVENTION

The present invention is conceived to solve the problems of the conventional techniques as described above, and an aspect of the present invention is to provide a gas heater that employs an inexpensive fuel and is configured to permit sufficient mixture of air and fuel in order to improve an air-fuel ratio and combustion efficiency.

Another aspect of the present invention is to provide a dryer including such a gas heater.

In accordance with an aspect of the present invention, a gas heater includes: a cabinet; a gas tube disposed inside the cabinet to supply a gas into the cabinet; a nozzle provided to the gas tube; a mixing tube disposed to face the nozzle such that air and the gas can be mixed in the mixing tube; and a mixing member provided to the mixing tube to generate a vortex of air flowing into the mixing tube.

The mixing tube may be open at one end facing the nozzle and be formed with a mixing part having a larger diameter than the nozzle.

The mixing member may include protrusions formed at an inlet of the mixing tube.

The protrusions of the mixing member may be positioned at regular intervals to form a saw-tooth shape.

The mixing member may include a bent portion formed by bending the protrusion outwardly.

In accordance with another aspect of the present invention, a dryer includes a gas heater, wherein the gas heater includes a cabinet; a gas tube disposed inside the cabinet to supply a gas into the cabinet; a nozzle provided to the gas tube; a mixing tube connected to the nozzle such that air and the gas can be mixed in the mixing tube; an ignition plug provided to the mixing tube to generate an ignition spark; and a mixing member provided to the mixing tube to generate a vortex of air flowing into the mixing tube.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a schematic sectional view showing a flow passage of a conventional dryer;

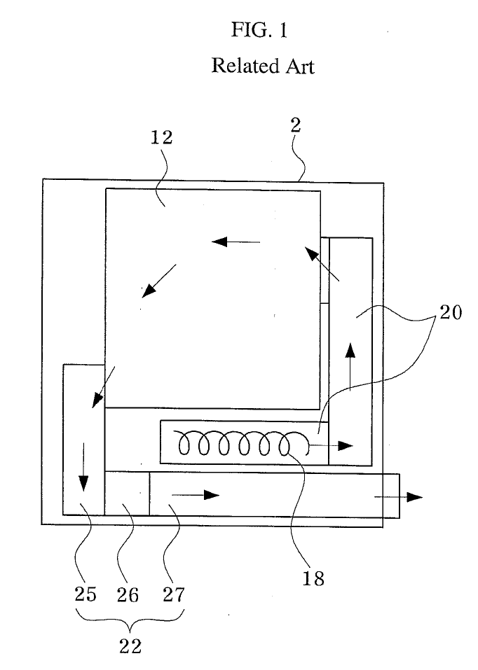

FIG. 2 is a partially cut-away perspective view of the conventional dryer;

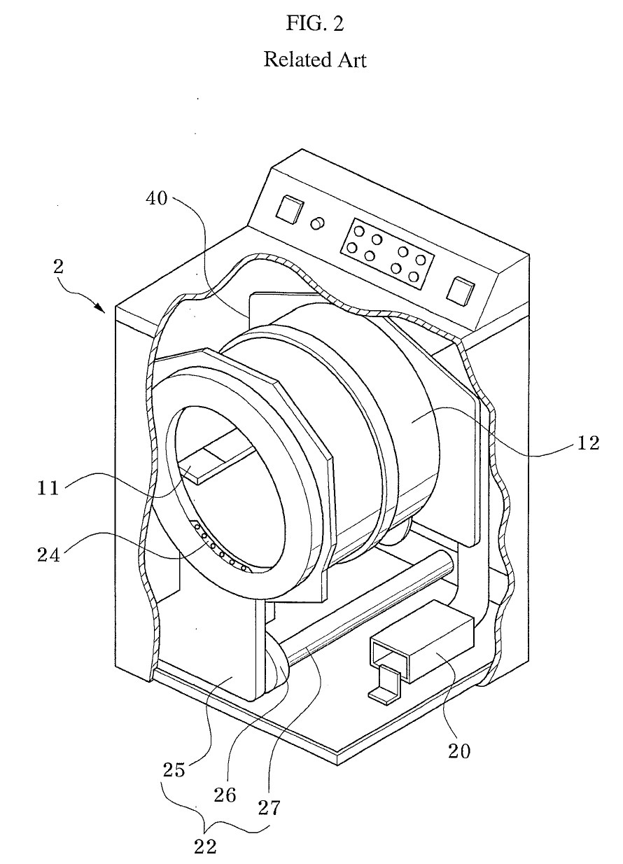

FIG. 3 is a configuration view of a dryer including a gas heater according to one embodiment of the present invention;

FIG. 4 is an exploded perspective view of a gas heater according to one embodiment of the present invention;

FIG. 5 is a partially enlarged view of a mixing tube of the gas heater according to the embodiment of the present invention;

FIG. 6 is a side-sectional view of the dryer including the gas heater according to the embodiment of the present invention, illustrating an intake path of the dryer;

FIG. 7 is a side-sectional view of the dryer including the gas heater according to the embodiment of the present invention, illustrating a circulation path of the dryer;

FIG. 8 is a side-sectional view of the dryer including the gas heater according to the embodiment of the present invention, illustrating an exhaust path of the dryer; and

FIG. 9 is a partially enlarged view of a mixing tube of a gas heater according to another embodiment of the present invention.

### DETAILED DESCRIPTION OF THE INVENTION

Exemplary embodiments of the present invention will be described in detail with reference to the accompanying drawings hereinafter. Herein, a dryer including a gas heater will be described as an example for convenience of description. The drawings may be exaggerated in thickness of lines or scale of components for the purpose of descriptive convenience and clarity only. Furthermore, terms used herein should be defined in consideration of functions of components of the present invention and thus can be changed according to the custom or intention of users or operators. Therefore, definition of such terms should be determined according to overall disclosures set forth herein.

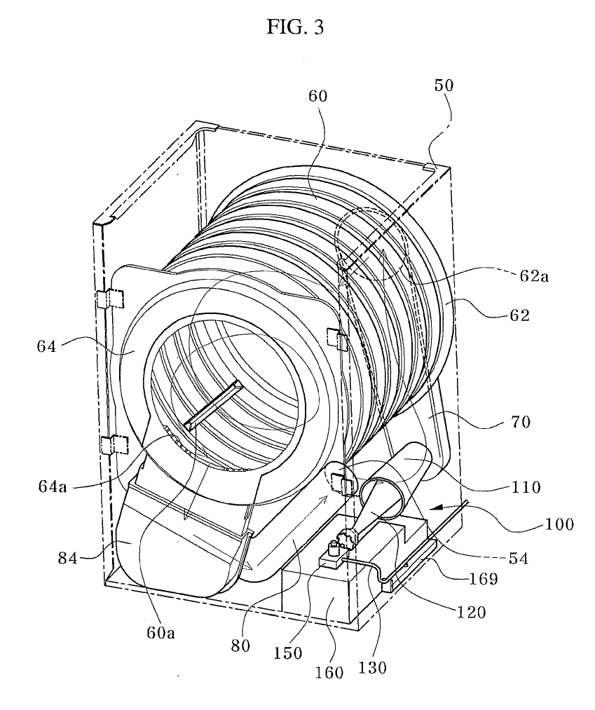

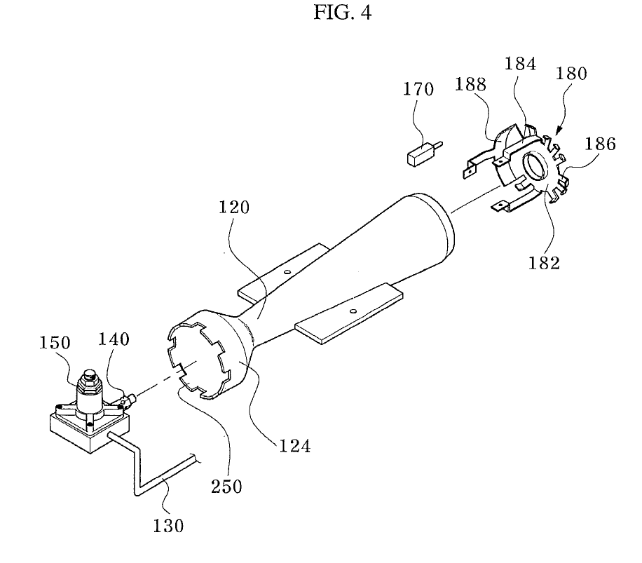

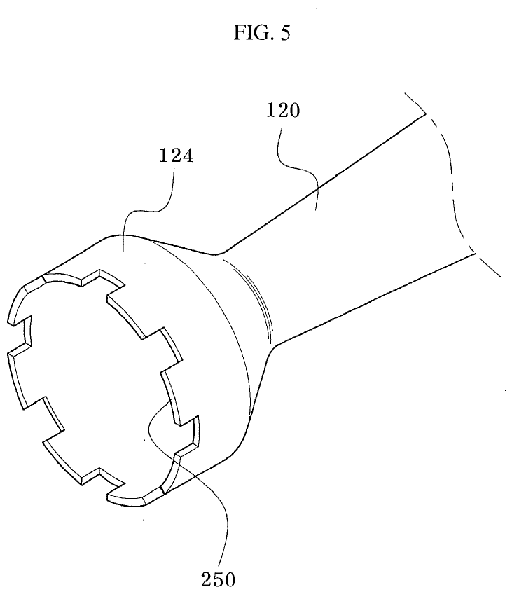

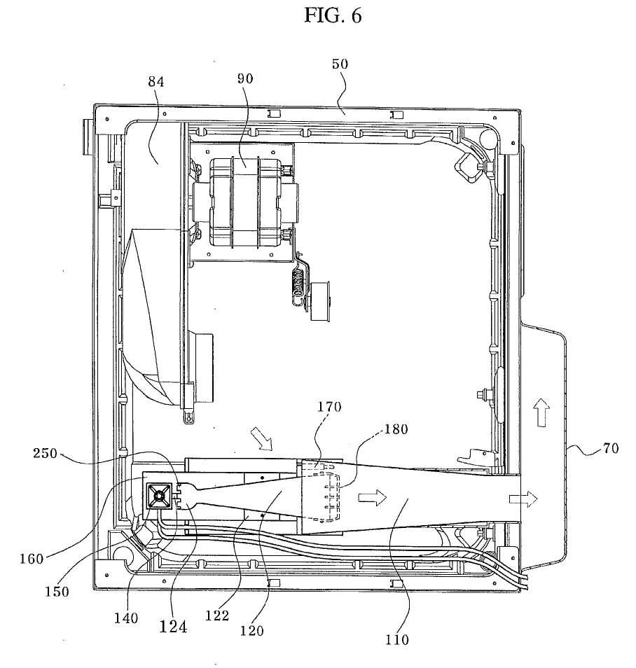

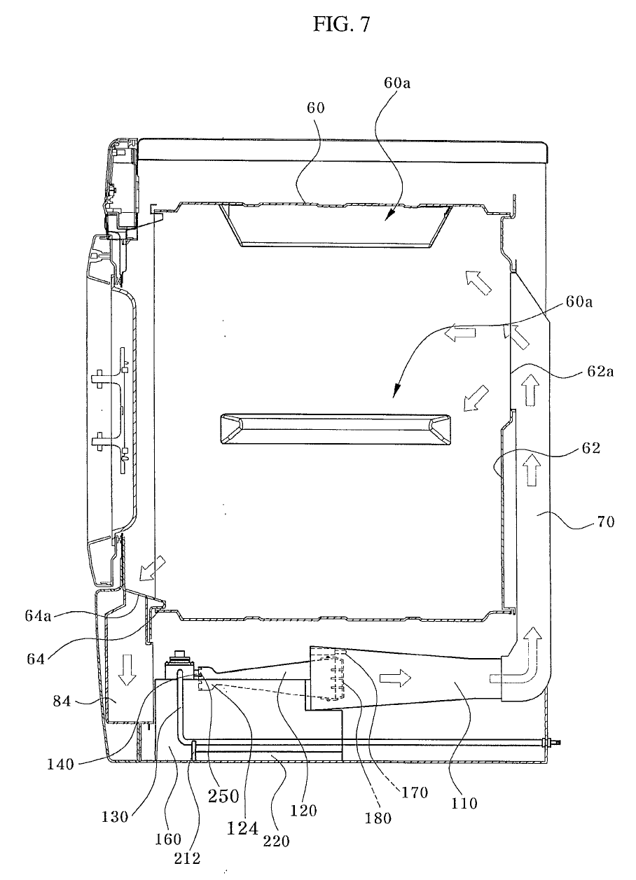

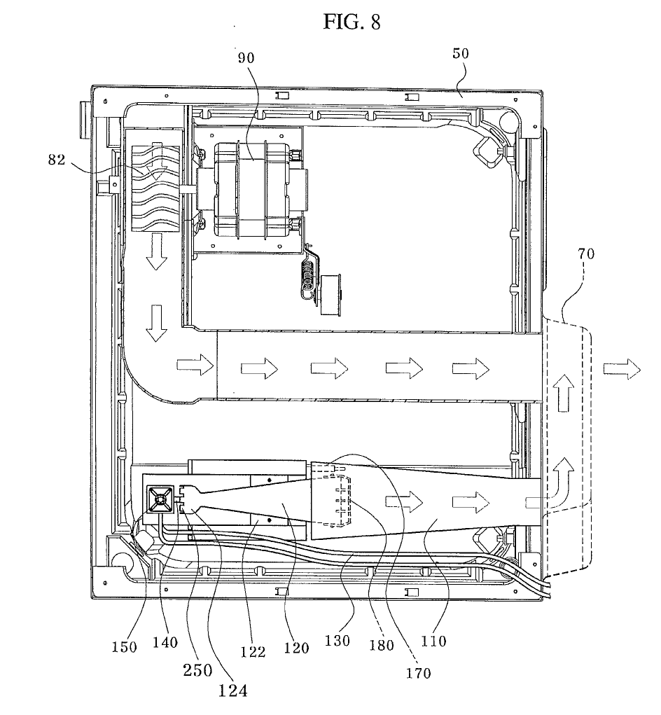

FIG. 3 is a configuration view of a dryer including a gas heater according to one embodiment of the present invention, FIG. 4 is an exploded perspective view of a gas heater according to one embodiment of the present invention, FIG. 5 is a partially enlarged view of a mixing tube of the gas heater according to the embodiment of the present invention, FIG. 6 is a side-sectional view of the dryer including the gas heater according to the embodiment of the present invention, illustrating an intake path of the dryer, FIG. 7 is a side-sectional view of the dryer including the gas heater according to the embodiment of the present invention, illustrating a circulation path of the dryer, and FIG. 8 is a side-sectional view of the dryer including the gas heater according to the embodiment of the present invention, illustrating an exhaust path of the dryer.

According to one embodiment of the present invention, the dryer includes a cabinet 50 having an air vent 54 and an opening through which laundry is placed into or removed from the cabinet 50, a drum 60 rotatably disposed inside the cabinet 50 to receive the laundry, a plurality of lifters 60a formed on an inner surface of the drum 60 to lift and drop the laundry rotating inside the drum 60, an intake duct 70 disposed inside the cabinet 50 to guide air into the drum 60, a heater 100 disposed at one side of the intake duct 70, an exhaust fan 82 disposed between the drum 60 and the air vent 54, an exhaust duct 80 disposed between the exhaust fan 82 and the air vent 54, and a drive motor 90 connected to a rotational shaft of the exhaust fan 82.

When power is applied to the drive motor 90, the exhaust fan 82 is rotated to circulate air. After passing through an intake port, air is heated by the heater 100 and supplied into the drum 60 through the intake duct 70. Inside the drum 60, heated air directly contacts laundry to perform drying or sterilization thereof. Then, air is discharged outside the cabinet 50 through the air vent 54 via the exhaust duct 80 by the exhaust fan 82.

The drum 60 has a cylindrical shape and is opened at front and rear sides such that the opened front side of the drum 60 faces the opening of the cabinet 50. The rear side of the drum 60 is rotatably supported by a support panel 62 which has a through-hole 62a . That is, the support panel 62 is disposed between the rear side of the drum 60 and the rear side of the cabinet 50 to rotatably support the drum 60, and the through-hole 62a is connected to the intake duct 70.

A front panel 64 is disposed between the front side of the drum 60 and the opening of the cabinet 50, and has a discharge port 64a formed at a lower end of the front panel 64. The discharge port 64a is connected to an extension tube 84 extending toward the ventilation fan 82. A housing 86 is disposed between the extension tube 84 and the exhaust duct 80 to accommodate the ventilation fan 82 such that the ventilation fan 82 can rotate inside the housing 86.

The intake duct 70 defines a passage extending from the heater 100 to a rear upper portion of the cabinet 50 corresponding to the through-hole 62a. With this configuration, air inside the cabinet 50 can be heated to a predetermined temperature or more while passing through the heater 100. Then, the heated air moves to the upper side of the cabinet 50 along the intake duct 70 and flows into the drum 60 through the through-hole 62a. At this time, the drum 60 connected to the drive motor 90 via a belt (not shown) is rotated to increase a contact area between heated air and laundry, efficiently drying and sterilizing the laundry.

The heater 100 includes a gas tube 130 disposed at one side of the cabinet 50 to supply a gas into the cabinet 50, a nozzle 140 disposed at one end of the gas tube 130, a valve 150 disposed at one side of the gas tube 130, a mixing tube 120 disposed to face the nozzle 140 such that air and a gas can be sufficiently mixed in the mixing tube 120, an ignition plug 170 disposed outside the mixing tube 120 to generate an ignition spark, a guide tube 110 disposed outside the mixing tube 120 to guide heated air, a bracket 160 disposed on one inner wall of the cabinet 50 to mount the gas tube 130, mixing tube 120 and guide tube 110, a flame holder 180 disposed between the mixing tube 120 and the guide tube 110 to prevent a flame generated by the ignition plug 170 from exceeding a predetermined size, and a mixing member 250 provided to the mixing tube 120 and located near the nozzle 140 to generate a vortex of the gas injected from the nozzle 140.

When the valve 150 is opened, a gas is supplied into the mixing tube 120 through the gas tube 130. Here, the gas is mixed with air inside the cabinet 50 to form a gas-air mixture, which is ejected from the mixing tube 120. At this time, the ignition plug 170 sparks to generate a flame in the mixture. Then, the flame holder 180 adjusts the size and location of the flame such that the flame is located inside the guide tube 110. Consequently, air flowing along the guide tube 110 is heated to hot air while passing through the flame and is supplied to laundry, thereby performing the drying operation.

The mixing tube 120 has a mixing part 124 to which air inside the cabinet 50 flows. The mixing part 124 is formed as an opening having a larger diameter than that of the nozzle 140 such that the gas injected from the nozzle 140 can enter the mixing tube 120 therethrough and be mixed with air inside the cabinet 50. The mixing part 124 is formed by extending one end of the mixing tube 120 and has a hollow cylindrical shape, one end of which faces the nozzle 140. In this embodiment, the mixing member 250 has protrusions formed at an inlet of the mixing tube 120. Preferably, the protrusions are positioned at regular intervals to form a saw-tooth shape.

When air flows into the mixing tube 120 through the saw-tooth shaped protrusions, a vortex is generated in the mixing tube 120 so that the air is efficiently mixed with the gas injected from the nozzle 140, thereby improving a gas-fuel ratio. As such, the vortex of air is mixed with the gas injected from the nozzle 140 and external air supplied through the opening to produce a gas-air mixture, which in turn is combusted while being discharged from the mixing tube 120.

The flame holder 180 is disposed between the mixing tube 120 and the guide tube 110. The flame holder 180 includes a ring-shaped body 182, a plurality of supporting fingers 184 extending from one side of the body 182 and coupled to the other end of the mixing tube 120, and a cover 188 formed at one side of the supporting finger 184 corresponding to the ignition plug 170 to separate the mixing tube 120 from the ignition plug 170. Further, the flame holder 180 includes a plurality of wings 186 radially extending from the body 182 between the supporting fingers 184. Here, each of the wings 186 is bent at an angle toward the mixing tube 120 and the cover 188 is formed by circumferentially extending a part of the supporting finger 184 by a predetermined distance.

When injected outside the mixing tube 120, the gas-air mixture is combusted by sparks from the ignition plug 170. Here, since the gas-air mixture is suppressed from contacting the ignition plug 170 by the cover 188 as soon as the gas-air mixture is ejected from the mixing tube 120, a flame is formed at a location separated a predetermined distance from the mixing tube 120. Further, since the injected gas-air mixture is distributed by the body 182 and wings 186 of the flame holder 180, the flame is not elongated along the guide tube 110, but is gathered near the flame holder 180. As such, since the flame is concentrated on an inner center of the guide tube 110, the mixing tube 120 and the intake duct 70 can be prevented from being deformed or damaged due to the flame.

Operation of a dryer including the gas heater according to the embodiment of the present invention will be described below.

First, when an operation button (not shown) is pressed, power is applied to the drive motor 90 and the heater 100 to drive the ventilation fan 82 and the drum 60. As the ventilation fan 82 is driven, air is introduced into the cabinet 50 through the intake port. In the cabinet 50, air flows toward the upper side of the cabinet 50 through the intake duct 70 which is extended in the vertical direction on the rear side of the cabinet 50. At this time, air is heated into dry hot air having a predetermined temperature or more by the heater 100. Then, the dry hot air is supplied into the drum 60 through the intake duct 70, and directly contacts laundry as a vortex to perform a drying operation.

Since the discharge port 64a is formed in the front panel 64 disposed between the opening of the drum 60 and the inner wall of the cabinet 50, air is discharged from the drum 60 through the discharge port 64a after performing the drying operation. Then, the discharged air flows into the housing 86 of the ventilation fan 82 through the extension tube 84 communicating with the discharge port 64a and is exhausted from the cabinet 50 through the air vent 54 via the exhaust duct 80.

Operation of the gas heater 100 will be described hereinafter. Upon starting the drying operation, the valve 150 is opened to allow the nozzle 140 to inject a gas into the mixing tube 120 where the gas is mixed with air flowing into the mixing tube 120. At this time, when flowing into the mixing tube 120 through the mixing part 124, air passes through the mixing member 250, which comprises the plural protrusions positioned at regular intervals to form the saw-tooth shape, so that a vortex of air is generated by means of the mixing member 250, enabling sufficient mixture between the gas and air. In other words, when air flows into the mixing tube 120 through the mixing part 124, the mixing part 124 generates the vortex of air, which causes the air to be sufficiently mixed with the gas inside the mixing tube 120. Consequently, combustion performed outside the mixing tube 120 can be promoted, thereby improving combustion efficiency. Here, when the gas-air mixture is ejected from the mixing tube 120, a flame is generated by the ignition plug 170 disposed outside the mixing tube 120, that is, on an inner wall of the guide tube 110, so that thermal energy can be supplied to air flowing into the intake duct 70. Additionally, since the flame is gathered at the center of the guide tube 110 by the flame holder 180, the mixing tube 120 and the intake duct 70 are prevented from being deformed or damaged due to the flame. Specifically, the cover 188 of the flame holder 180 separates the gas-air mixture from the ignition plug 170 at an outlet of the mixing tube 120, so that the flame is not formed near the mixing tube 120 and the gas-air mixture is dispersed by the body 182 and wings 186 of the flame holder 180. Consequently, the flame can be suppressed from being elongated into the guide tube 110 and can be prevented from entering the intake duct 70.

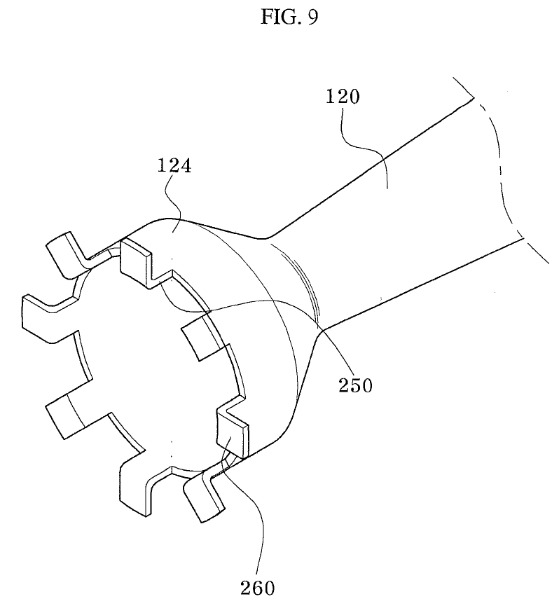

FIG. 9 is a partially enlarged view of a mixing tube of a gas heater according to another embodiment of the present invention.

In this embodiment, a mixing member 250 further includes a bent portion 260 which is formed by bending a portion of a protrusion. Hence, when air flows through the bent portion 260 and the protrusion, generation of a vortex is further promoted, thereby achieving more complete mixture of air and gas.

As apparent from the above description, according to the present invention, the gas heater and the dryer including the same are configured to employ a gas to supply thermal energy into a drum, thereby reducing time and cost for a drying operation.

Further, the gas heater of the present invention includes a mixing member comprising protrusions positioned at regular intervals on a mixing part of a mixing tube to generate a vortex of air flowing into the mixing tube through the protrusions of the mixing member. Hence, air can be sufficiently mixed with a gas inside the mixing tube and blow-by gas can be suppressed, thereby improving combustion efficiency.

Although the present invention has been described with reference to the embodiments and the accompanying drawings, the embodiments and drawings are given by way of illustration only, and, it will be apparent to those skilled in the art that various modifications and equivalent other embodiments can be made without departing from the scope of the present invention. In addition, although the present invention has been described with reference to the gas heater for the dryer as specifically disclosed herein, it should be noted that the gas heater for the dryer has been illustrated as an example, and that the gas heater of the present invention may be applied to other gas heaters without being limited to the gas heater for the dryer. Therefore, the scope and spirit of the invention is limited only by the claims set forth herein as follows.

What is claimed is:

1. A gas heater comprising:
a cabinet;
a gas tube disposed inside the cabinet to supply a gas into the cabinet;
a nozzle provided to the gas tube;
a mixing tube disposed to face the nozzle such that air and the gas can be mixed in the mixing tube; and
a mixing member provided to the mixing tube to generate a vortex of air flowing into the mixing tube.

2. The gas heater according to claim 1, wherein the mixing tube is open at one end facing the nozzle and is formed with a mixing part having a larger diameter than the nozzle.

3. The gas heater according to claim 1, wherein the mixing member comprises protrusions formed at an inlet of the mixing tube.

4. The gas heater according to claim 3, wherein the protrusions are positioned at regular intervals to form a saw-tooth shape.

5. The gas heater according to claim 3, wherein the protrusion has a bent portion bent outwardly.

6. A dryer comprising a gas heater,
the gas heater comprising:
a cabinet;
a gas tube disposed inside the cabinet to supply a gas into the cabinet;
a nozzle provided to the gas tube;
a mixing tube connected to the nozzle such that air and the gas can be mixed in the mixing tube;
an ignition plug provided to the mixing tube to generate an ignition spark; and
a mixing member provided to the mixing tube to generate a vortex of air flowing into the mixing tube.

7. The dryer according to claim 6, wherein the mixing tube is open at one end facing the nozzle and is formed with a mixing part having a larger diameter than the nozzle.

8. The dryer according to claim 6, wherein the mixing member comprises protrusions formed at an inlet of the mixing tube.

9. The dryer according to claim 8, wherein the protrusions are positioned at regular intervals to form a saw-tooth shape.

10. The dryer according to claim 8, wherein the protrusion has a bent portion bent outwardly.
